(19) United States
(12) Patent Application Publication
(10) Pub. No.: US 2001/0013019 A1
(43) Pub. Date: Aug. 9, 2001

(54) Electronic settlement system

(76) Inventors: Hirobumi Sugiyama, Saitama (JP); Shinji Yamazaki, Saitama (JP); Osamu Yamashita, Saitama (JP)

Correspondence Address: RABIN & CHAMPAGNE, PC, 1101 14TH STREET, NW, SUITE 500, WASHINGTON, DC, 20005, US

(21) Appl. No.: 09/769,449

(22) Filed: Jan. 26, 2001

(30) Foreign Application Priority Data
Feb. 3, 2000 (JP) 026330/2000

(51) Int. Cl. G06F 17/60

(52) U.S. Cl. 705/41; 705/39; 235/380

(57) ABSTRACT

An electronic settlement system is provided which allows a user to properly and selectively use a plurality of server wallets by using only a single user personal computer.

A user personal computer of a client is provided with a first wallet connecting module corresponding to a first server wallet and a second wallet connecting module corresponding to a second server wallet. The user personal computer is provided with a selector used to select the first wallet connecting module and the second wallet connecting module and the selector selects either of the first wallet connecting module or the second wallet connecting module.

### BACKGROUND OF THE INVENTION

1. Field of the Invention

The present invention relates to an electronic settlement system suited for an electronic settlement using an SET (Secure Electronic Transaction) being a communication standard to safely conduct electronic commerce on networks such as the Internet and more particularly to the electronic settlement system that allows a customer to select any one of a plurality of settlement institutions.

2. Description of the Related Art

In recent years, as electronic commerce has become widespread, a variety of methods for safely conducting electronic commerce on the Internet have been proposed. Expectations with respect to the electronic settlement based on the SET, which is a communication standard to assure more highly safety in electronic commerce, are expanding and related services have been already opened by financial institutions including, for example, credit card companies. The SET is a specification of a communication protocol aimed at achieving the safe electronic settlement by a credit card on the Internet.

The electronic settlement system based on the SET chiefly includes a wallet being software used when a shopping user takes a procedure for the SET-based settlement by credit cards, a merchant POS (Point-Of-Sales) system provided on a visual online shop on the Internet, software such as a settlement gateway provided between the merchant POS system and the settlement institution serving to settle accounts and a certificate authority to issue a certificate to certify that each of the shopping users, visual online shops and settlement institutions is a duly authorized person, a party or an institution.

Recently, a server-management-type wallet configured so as to intensively and collectively manage functions of wallets that can be used by a plurality of users is becoming widespread. In the electronic settlement system provided with the server-management-type wallet, a wallet connecting module as a client to receive service from the server is installed in each of the user terminals, which is used to access to the server through the Internet so that the user can take a procedure for settlements.

As shown in FIG. 2, in a conventional electronic settlement system 100, a server wallet (SW) 10 operating as the server-management-type wallet which is adapted to intensively and collectively manage functions of a plurality of wallets is connected to a personal computer (user PC) 20 being a user's terminal used to access to the server wallet 10 at a time of settlements by the user through the Internet 30. Though a merchant POS and a certificate authority are not shown in FIG. 2, they are connected to the Internet 30. The server wallet 10 is accessed by the user PC 20 through the wallet connecting module (WUM) 21 installed in the user PC 20 and serves as a server to manage users' wallets to perform functions of the wallet for settlements of the user. The wallet connecting module 21 installed in the user PC 20 is a client which receives services from the server wallet 10. In the conventional electronic settlement system 100, the user uses the wallet connecting module 21 installed in the terminal to receive services required for taking procedures for the SET-based settlements, from the server wallet 10 by remote operations.

However, in the conventional electronic settlement system, only a single wallet connecting module which allows the user to use only a single specified settlement institution is installed in each of the user terminals. Therefore, the user cannot control from one single user's terminal so as to use two or more different server wallets selectively and properly.

### SUMMARY OF THE INVENTION

In view of the above, it is an object of the present invention to provide an electronic settlement system which allows a user to properly and selectively use a plurality of server wallets by using only a single terminal.

According to a first aspect of the present invention, there is provided an electronic settlement system including:

a shop connected to a communication network;

a plurality of terminals connectable to the network;

a plurality of settlement institutions connected to the network;

servers connected to the network and provided so as to correspond to each of the settlement institutions, which are operated to manage two or more pieces of software installed for each customer in order to take procedures for settlement of electronic commerce for a plurality of customers using the shop on the communication network by operating each of the terminals; and

wherein each of the terminals is provided with a plurality of connecting modules installed so as to correspond to each of the servers and operated to connect each of the terminals to each of the servers through the communication network so that the customer is able to take procedures for settlement and with a selecting module used to select the connecting module corresponding to the server from the two or more connecting modules provided to each of the terminals to use the server corresponding to the settlement institution.

In the foregoing, a preferable mode is one wherein each of the terminals is operated to receive a message showing a request for the procedures for settlement from the shop and, after having received the message, in order to start the procedures for settlement, transfers the message from the selecting module through a desired connecting module selected out of the connecting modules to the server corresponding to the desired connecting module.

Also, a preferable mode is one wherein the selecting module, before each of the terminals receives the message, is operated to prompt the customer to select the connecting module using a screen display which is provided to facilitate selection of the connecting module corresponding to the settlement institution that each of the customers is able to use for settlement and wherein the desired connecting module is the one selected by each of the customers using the screen display.

Also, a preferable mode is one wherein the selecting module, when each of the terminals has received the message, is operated to prompt the customer to select the connecting module using the screen display which is provided to facilitate selection of the connecting module corresponding to the settlement institution that each of the customers is able to use for settlement and wherein the desired connecting module is the one selected by each of the customers using the screen display.

Also, a preferable mode is one wherein the selecting module, when each of the terminals has received the message, is operated to select the connecting module used to connect each of the terminals to the server corresponding to the settlement institution designated by the message, based on information indicating which settlement institution allows each of the servers corresponding to each of the two or more connecting modules installed on each of the terminals to be used for electronic settlement.

Also, a preferable mode is one wherein each piece of the information is given to the selecting module which then transfers the message to the connecting module selected based on each piece of the information.

Also, a preferable mode is one wherein each piece of the information is given to each of the connecting modules and the selecting module then transfers the message to the connecting module selected based on each piece of the information held by each of the connecting modules.

Also, a preferable mode is one wherein each piece of the information is given to each of servers and the selecting module then transfers the message to the connecting module based on each piece of the information held by each of the servers.

According to a second aspect of the present invention, there is provided an electronic settlement system including:

a shop connected to a communication network;

a plurality of terminals connectable to the network;

a plurality of settlement institutions connected to the network;

servers connected to the network and provided so as to correspond to each of the settlement institutions, which are operated to manage two or more pieces of software installed for each customer in order to take procedures for settlement of electronic commerce for a plurality of customers using the shop on the communication network by operating each of the terminals; and

wherein each of the terminals is provided with a single connecting module used to connect each of the terminals to a desired server selected out of the two or more servers through the communication network so that the customer is able to take the procedures for settlement.

In the foregoing, it is preferable that the connecting module is used to automatically connect each of the terminals to the server based on information indicating which settlement institution allows each of the servers to be used for electronic settlement.

Also, it is preferable that each of the servers holds each piece of the information and each of terminals obtains each piece of the information from each of servers through the connecting modules.

Also, it is preferable that each of the terminals receives a message showing a request for procedures for settlement from the shop and, after having received the message, in order to start the procedures for settlement, transfers the message through the connecting module to the server corresponding to the settlement institution designated by the message being the server selected based on each piece of the information.

Also, it is preferable that a proxy server enabling selective connection between each of the terminals and each of the servers is connected as a master server to the communication network and each of the terminals is able to be connected through the master server to each of the servers as each of slave servers being provided so as to correspond to each of the settlement institutions.

Also, it is preferable that each of the terminals receives the message showing the request for procedures for settlement from the shop and, after having received the message, in order to start the procedures for settlement, transfers the message through the connecting modules to the master servers.

Also, it is preferable that the master server is provided with a auxiliary connecting module used to connect each of the terminals to each of slave servers through the master server in cooperation with the connecting module of each of the terminals.

Also, it is preferable that each of the information is stored collectively in the master server and the master server is used to connect each of the terminals through the auxiliary connecting module to the desired slave server based on the collective information.

Also, it is preferable that the master server is provided with a certificate acquiring module used to obtain, from each of the slave servers, a certificate to certify that each customer is a duly authorized person for procedures for settlement, which is given to each of customers who is allowed to use the settlement institution.

Also, it is preferable that each piece of the information is stored in the master server and the master server obtains, based on the collective information, in order to take procedures for settlement instead of each of the slave servers, the certificate through the certificate acquiring module from the desired slave server.

Also, it is preferable that the master server holds slave server information about the slave servers connected to the communication network.

Also, it is preferable that a proxy server enabling selective connection between each of the terminals and each of the servers is connected as a master server to the communication network and each of the terminals is able to be connected through the master server to each of the servers as each of slave servers being provided so as to correspond to each of the settlement institutions.

Also, it is preferable that the master server, in order to connect each of the terminals to each of the slave servers desired by each of customers, receives a notification about communication addresses of the slave server through the connecting module from the terminal of the customer.

Also, it is preferable that each piece of the information is collectively stored in the connecting module of each of the terminals and, each of the terminals, in order to connect each of the terminals to the desired slave server through the master server, sends the collective information from the connecting module to the master server.

Furthermore, it is preferable that the connecting module of each of the terminals is fed with the slave server information about the slave servers connected to the communication network and each of the terminals sends the slave server information from the connecting module to the master server to connect each of terminals to the desired slave server through the master server.

### BRIEF DESCRIPTION OF THE DRAWINGS

The above and other objects, advantages and features of the present invention will be more apparent from the following description taken in conjunction with the accompanying drawings in which:

FIG. 1 is a schematic block diagram of an electronic settlement system of a first embodiment of the present invention;

FIG. 2 is a schematic block diagram of a conventional electronic settlement system;

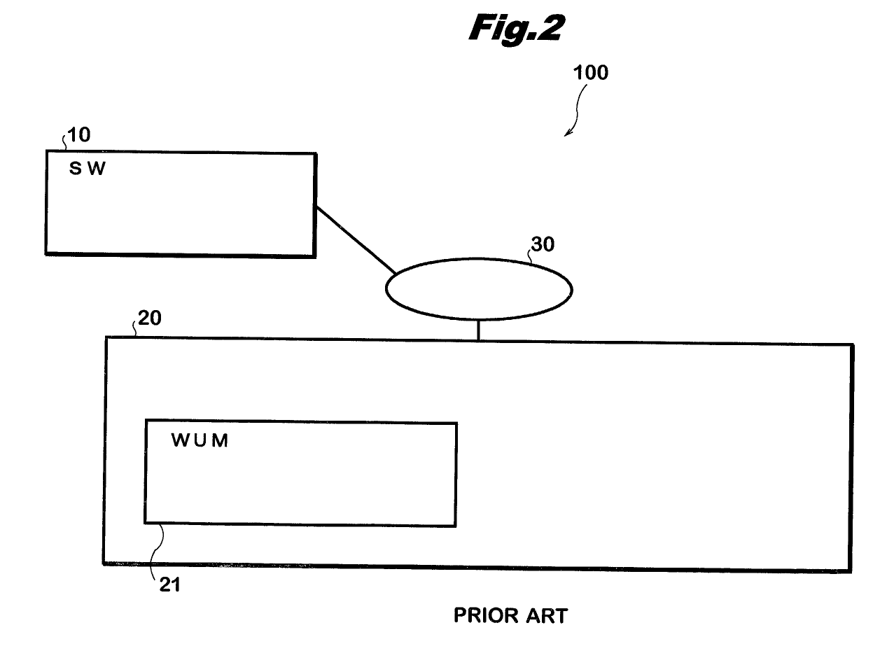

FIG. 3 is a schematic block diagram of an electronic settlement system of a second embodiment of the present invention;

FIG. 4 is a schematic block diagram of an electronic settlement system of a third embodiment of the present invention;

FIG. 5 is a schematic block diagram of an electronic settlement system of a fourth embodiment of the present invention;

FIG. 6 is a schematic block diagram of an electronic settlement system of a fifth embodiment of the present invention;

FIG. 7 is a schematic block diagram of an electronic settlement system of a sixth embodiment of the present invention;

FIG. 8 is a schematic block diagram of an electronic settlement system of a seventh embodiment of the present invention;

FIG. 9 is a schematic block diagram of an electronic settlement system of an eighth embodiment of the present invention;

FIG. 10 is a schematic block diagram of an electronic settlement system of a ninth embodiment of the present invention;

FIG. 11 is a schematic block diagram of an electronic settlement system of a tenth embodiment of the present invention;

FIG. 12 a schematic block diagram of an electronic settlement system of an eleventh embodiment of the present invention; and

FIG. 13 a schematic block diagram of an electronic settlement system of a twelfth embodiment of the present invention

### DESCRIPTION OF THE PREFERRED EMBODIMENTS

Best modes of carrying out the present invention will be described in further detail using various embodiments with reference to the accompanying drawings.

### First Embodiment

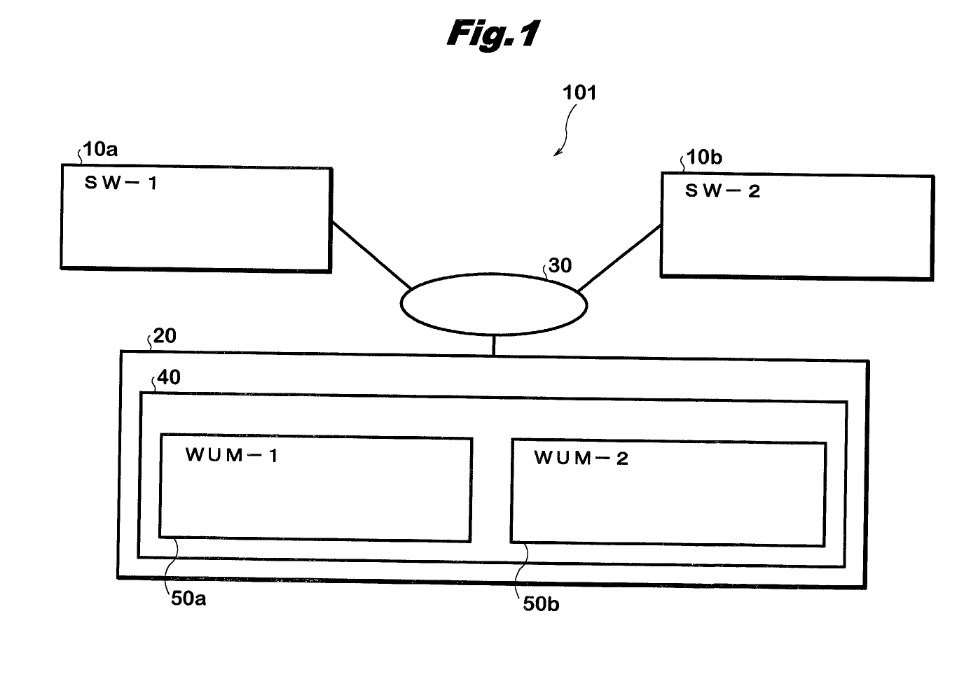

FIG. 1 is a schematic block diagram of an electronic settlement system of a first embodiment of the present invention. The electronic settlement system 101 of the first embodiment is to be used to perform a well-known SET-based electronic settlement to settle accounts by credit cards in electronic commerce on the Internet. As shown in FIG. 1, in the electronic settlement system 101 of the first embodiment, a first server wallet (SW-1) 10a and a second server wallet (SW-2) 10b are connected to a personal computer (that is, a user PC) 20 to be operated by the user who is a customer for the electronic settlement system on the Internet 30. The personal computer 20 being used as a user terminal is provided with a selector 40, a first wallet connecting module (WUM-1) 50a and a second wallet connecting module (WUM-2) 50b. Configurations and operations of each of the first wallet connecting module 50a and second wallet connecting module 50b are the same as those of the conventional wallet connecting module described above. The selector 40 is a WUM selection module adapted to select either the first wallet connecting module 50a or the second wallet connecting module 50b. Each of the first wallet connecting module 50a and the second wallet connecting module 50b installed in the personal computer 20 is operated as a wallet client to perform the electronic settlement based on the SET and corresponds to the server wallets 10a and 10b respectively. The selector 40 is made up of software packages to perform selecting processing and of processors to execute the software packages or a like. Each of the first wallet connecting module 50a and the second wallet connecting module 50b is also made up of software packages to perform the processing of electronic settlements with each of the server wallets 10a and 10b and of processors to execute the software packages.

In the electronic settlement system 101 of the first embodiment, the user can use either the server wallet 10a or the server wallet 10b, whichever the user desires, to perform the settlement processing. To achieve this, the user selects either the first wallet connecting module 50a or the second wallet connecting module 10b, which corresponds to the first server wallet 10a and the second server wallet 10b respectively.

Next, operations of and procedures for using the user PC 20 and both the server wallets 10a and 10b employed in the electronic settlement system 101 of the first embodiment will be explained below.

(1) In the electronic settlement system 101, the user selects the wallet connecting module 50a and 50b before taking procedures for settlement of shopping accounts. That is, before the user PC 20 receives a request for taking the procedure for the settlement from a merchant POS (not shown) installed in a visual online shop (now shown), the selector 40 prompts the user to select either the first wallet connecting module 50a or the second wallet connecting module 50b. To prompt the user to select, a method in which a screen display is produced can be used. At this point, let it be assumed that the user has selected, for example, the first wallet module 50a in order to use the first server wallet 10a. The selector 40 stores data that the first wallet module 50a has been selected by the user as a wallet connecting module for the settlement of the shopping account.

(2) When the procedure is taken for the settlement of the shopping accounts, a start message for the settlement (a wake-up message) is sent out from the merchant POS to the user PC 20 on the Internet. The start message is a message showing that processing of the electronic settlement is commenced, which includes, for example, information about goods purchased by the user, information about a brand of a settlement institution or a like.

(3) The user PC 20, when receiving the start message, starts a selector 40 in the user PC 20. The selector 40 then selects the first wallet connecting module 50a that has been selected by the user and has been already stored and transfers the start message to the wallet connecting module 50a.

(4) The first wallet connecting module 50a, in accordance with the start message fed from the selector 40, performs ordinary SET settlements in cooperation with the first server wallet 10a. That is, the start message is sent from the user PC 20 through the first wallet connecting module 50a to the first server wallet 10a. Then, both the first server wallet 10a that has received the start message and the first wallet connecting module 50a carry out predetermined procedures for SET-based settlements in cooperation with each other. If the user selects the second wallet connecting module 50b, as in the case where the user selects the first wallet connecting module 50a, the selector 40 feeds the start message to the second connecting module 50b which carries out predetermined SET-settlements in cooperation with the second server wallet 10b.

As described above, in the electronic settlement system 101 of the first embodiment, before the user receives the start message from the visual online shop, the selector 40 prompts the user to select the wallet connecting module corresponding to the server wallet that the user wants to use, out of the two or more wallet connecting modules. Then, after the start message is actually sent from the visual online shop to the user, the start message is fed from the user PC 20 to the desired server wallet through the wallet connecting module selected in advance and then the procedures for the SET settlement are started.

Thus, according to the electronic settlement system 101 of the first embodiment, since a plurality of the wallet connecting modules each corresponding to each of the two or more server wallets is installed in the single user terminal and since the selector used to select in advance, before the start of procedures for the settlement, the desired wallet connecting module corresponding to a desired settlement institution is mounted, the user can control from the single user terminal so as to use two or more different server wallets selectively and properly.

### Second Embodiment

In the electronic settlement system of the above first embodiment, before the start of settlement procedures, the wallet connecting module is selected by the selector of the user PC 20. However, in an electronic settlement system of a second embodiment, when the user PC 20 receives a start message from the POS, that is, at a time of the start of settlement procedures, selection of one wallet connecting module out of a plurality of wallet connecting modules is instructed.

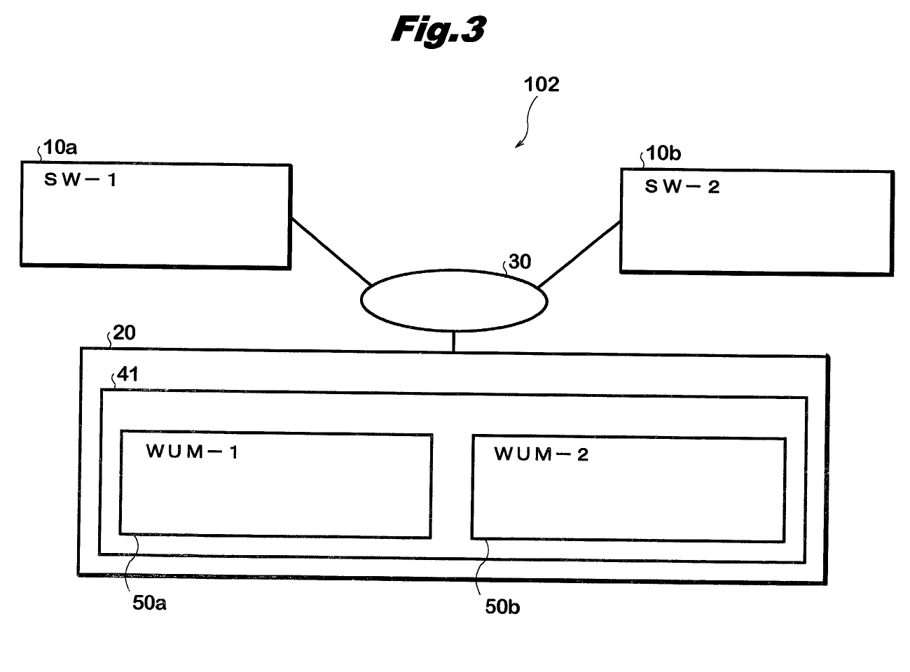

In the electronic settlement system 102 of the second embodiment, as shown in FIG. 3, a first server wallet (SW-1) 10a, a second server wallet (SW-2) 10b are connected to a user's personal computer (user PC) 20 through the Internet 30 as in the case of the first embodiment. The user PC 20 is provided with a selector 41, a first wallet connecting module (WUM-1) 50a and a second wallet connecting module (WUM-2). Configurations of the wallet connecting modules 50a and 50b are the same as those in the first embodiment. The selector 41, on receiving the start message for the settlement from the POS, starts the same procedures to select either the first wallet connecting module 50a or the second wallet connecting module 50b as in the first embodiment.

Procedures for operation of the user PC 20 and the first and second server wallets 10a and 10b in the second embodiment will be described below.

(1) When procedures for the settlement for shopping are started, a start message is sent from the POS to the user PC 20.

(2) When the user PC 20 receives the start message, the selector 41 prompts the user to select either the first wallet connecting module 50a or the second wallet connecting module 50b. To prompt the user to select, as in the case of the first embodiment, a screen display of the user PC 20 can be produced.

(3) When the selection is made after the receipt of the start message, for example, if the user selects the first wallet connecting module 50a, the selector 41 transfers the start message to the first wallet connecting module 50a.

(4) The first wallet connecting module 50a, in response to the start message, takes predetermined procedures for the SET-based settlement in cooperation with the first server wallet 10a. That is, the first wallet connecting module 50a that has received the start message, as in the case of the first embodiment, transfers the message to the first server wallet 10a. Then, the first server wallet 10a having received the start message and the first wallet connecting module 50a take procedures for the SET-based settlement in cooperation with each other. On the other hand, if the user selects the second wallet connecting module 50b, the second wallet connecting module 50b and the second server wallet 10b take procedures for the settlement in the same way as in the case where the first wallet connecting module 50a is selected. In the electronic settlement system 102, when the user's terminal 20 receives the start message for settlement, the selector 41 instructs the user to select one desired wallet connecting module out of two or more wallet connecting modules.

Thus, according to the electronic settlement system 102 of the second embodiment, the user can selectively and properly use a plurality of different server wallets by using only the single terminal and, since the user can select the wallet connecting module for the settlement at the time of receiving the start message, the user can select a desired settlement institution out of a plurality of settlement institutions designated by the visual online shops.

### Third Embodiment

In an electronic settlement system of a third embodiment, a selector of the user PC 20 is given information about a brand showing information about each of settlement institutions to which each server wallet corresponds.

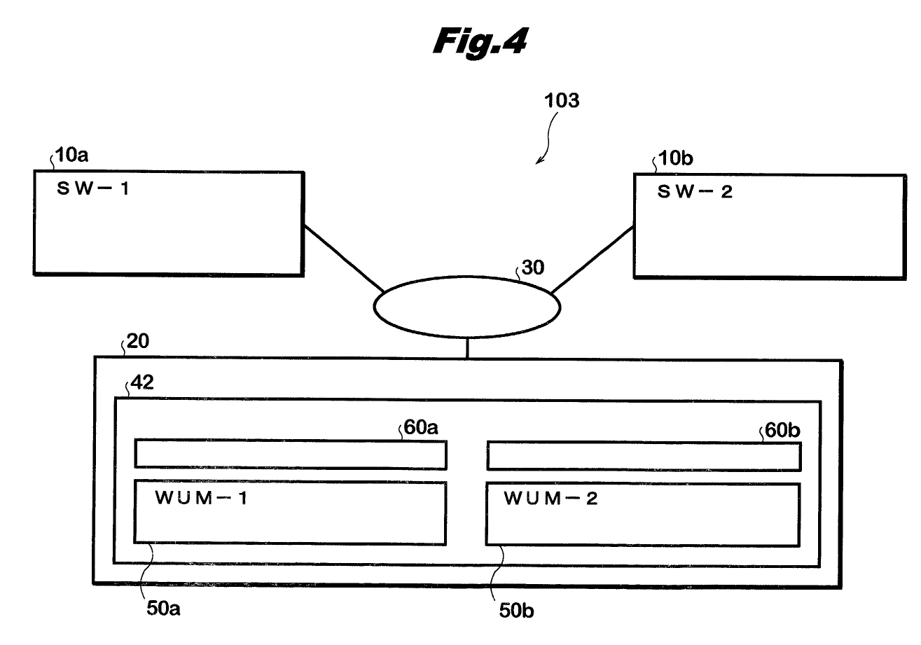

In the electronic settlement system 103 of the third embodiment, as shown in FIG. 4, a first server wallet 10a and a second server wallet 10b are connected to a user personal computer (a user PC) 20 through the Internet 30, as in the case of the first and second embodiments. The user PC 20 is provided with a selector 42 and both wallet connecting modules (WUM-1) 50a and (WUM-2) 50b each having the same configurations as in the first and second embodiments. The selector 42 has brand information about the first server wallet 10a (SW-1 brand information 60a) and brand information about the second server wallet 10b (SW-brand information 60b). When the user PC 20 receives a start message for settlement from the POS, the selector 42 makes a reference to the brand information 60a and 60b in order to automatically select the wallet connecting module corresponding to the brand designated by the start message and performs specified selection of the wallet connecting module. Each of the brand information 60a and 60b is information showing by which settlement institution the first server wallet 10a and the second server wallet 10b can be settled by way of the electronic settlement. The brand information 60a is information showing that the server wallet 10a can be settled by the brand A while the brand information 60b is information showing that the server wallet 10b can be settled by the brand B.

In the electronic settlement system 103 of the third embodiment, procedures for the SET-based settlement are taken in accordance with the following steps. In the procedures described below, the brand A is used as one of examples of settlement institutions designated by the visual online shop.

(1) When procedures for the settlement for shopping are started, a start message is sent from the POS to a user personal computer 20.

(2) When the user PC receives the start message, the selector 42 of the user PC 20 makes a reference to the brand information 60a and 60b held by the selector 42. The selector 42 recognizes, based on the brand information 60a obtained as a result of the reference, that a server wallet to be used for the settlement using the brand A designated in the message is the first server wallet 10a and selects the first wallet connecting module 50a which is operated to correspond to the server wallet 10a as the wallet connecting module to be used for the settlement.

(3) The selector 42 transfers the start message fed from the POS to the selected first wallet connecting module 50a.

(4) The first wallet connecting module 50a having received the start message takes procedures for the SET-based settlement in response to the start message in cooperation with the first server wallet 10a. Moreover, if the brand B, instead of the brand A, is designated by the start message, procedures for the SET-based settlement are taken by the second wallet connecting module 50b and the second server wallet 10b in the same manner as are taken when the brand A is designated.

As described above, in the electronic settlement system 103 of the third embodiment, when the user PC 20 receives the start message for settlement, the selector 42 makes a reference to each brand information held by the selector 42 so that one of the two or more server wallets which corresponds to the settlement institution designated by the message is used. When the wallet connecting module corresponding to the designated server wallet is selected, the start message is sent from the selected wallet connecting module to the specified server wallet and procedures for the SET-based settlement.

Thus, according to the electronic settlement system 103 of the third embodiment, the user can control from the single user terminal so as to use two or more different server wallets selectively and properly. Moreover, the wallet connecting module for the settlement is automatically selected by the selector, thus preventing the user from erroneously selecting the server wallet having any one of the brands other than designated by the visual online shop.

Fourth Embodiment In the electronic settlement system 103 of the third embodiment, the brand information corresponding to each server wallet is held by the selector 42, however, in the electronic settlement system 104 of a fourth embodiment, the brand information is held by each of the wallet connecting modules of the user PC 20.

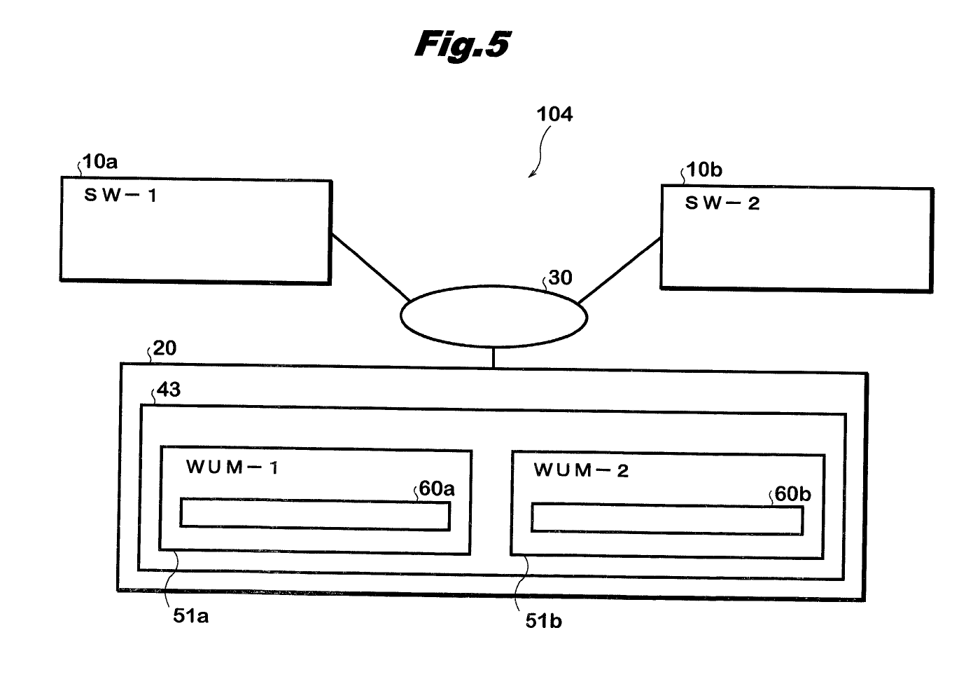

In the electronic settlement system 104 of the fourth embodiment, as shown in FIG. 5, a first server wallet 10a and a second server wallet 10b are connected to a user personal computer (a user PC) 20 through the Internet 30, as in the cases of the first and second embodiments. The user PC 20 includes a selector 43, a first wallet connecting module (WUM-1) 51a and a second wallet connecting module (WUM-2) 51b. The wallet connecting modules 51a and 51b have brand information 60a and 60b respectively. Contents of the brand information 60a and 60b are the same as those in the third embodiment. The brand information 60a is information showing that the first wallet 10a can be settled by a settlement institution called the brand A and the brand information 60b is information showing that the second wallet 10b can be settled by an settlement institution called the brand B, as in the case of the third embodiment. The selector 43, when receiving the start message from the POS, makes a reference to the brand information 60a and 60b held, respectively, by the wallet connecting modules 51a and 51b, and performs selection of either the first wallet connecting module 60a or the second wallet connecting module 60b. In the electronic settlement system 104 of the fourth embodiment, procedures for the SET-based settlement are taken in accordance with the following steps. In the procedures described below, as in the case of the third embodiment, the brand A is used as one of examples of settlement institutions designated by the visual online shop.

(1) When procedures for the settlement for shopping are started, the start message is sent from the POS to the user PC 20.

(2) When the user PC receives the start message, the selector 43 makes a reference to the brand information 60a and 60b held respectively by the first wallet connecting module 51a and the second wallet connecting module 51b to check which server wallet can be used for the settlement by the brand A designated by the start message.

(3) The selector 43 recognizes, based on the brand information 60a obtained as a result of the reference, that a server wallet to be used for the settlement using the brand A designated by the message is the first server wallet 10a and transfers the message to the first wallet connecting module 51a which is operated to correspond to the server wallet 10a.

(4) The wallet connecting module 51a, in response to the start message, takes predetermined procedures for the SET-based settlement, in cooperation with the first server wallet 10a, as in the case of the first to third embodiments. Moreover, if the brand B is designated by the start message, procedures for the SET-based settlement are taken by the second wallet connecting module 51a and the second server wallet 10b in the same manner as are taken when the brand A is designated.

As described above, in the electronic settlement system 104, the user PC 20 is provided with the wallet connecting module 61a and the wallet connecting module 51b being corresponded respectively to the server wallet 10a and to the server wallet 10b and these wallet connecting modules 5la and 51b are given information about the server wallet as brand information.

When the user PC 20 receives the start message for settlement, the selector 43 of the user PC 20 makes a reference to the brand information and transfers the start message to the wallet connecting module corresponding to the brand designated by the message.

Therefore, according to the electronic settlement system 104 of the fourth embodiment, the user can control from the single user terminal so as to use two or more different server wallets selectively and properly. Moreover, the wallet connecting module for the settlement is automatically selected by the selector, thus preventing the user from erroneously selecting the server wallet having any one of the brands other than designated by the visual online shop. Also, the brand information can be automatically updated through the Internet 30 by the supply of brand information to the wallet connecting modules 51a and 51b. That is, in a state where the brand information described above has been incorporated into the wallet connecting module, brand information about the server wallet can be updated when the brand information is periodically downloaded from the server wallet to the wallet connecting module. Reasons for this are as follows. That is, ordinarily, since update information is required for the wallet connecting modules described above and an amount of data about the information is small, the update information is periodically downloaded by the user through the Internet. Therefore, by downloading the data containing the brand information, the brand information can be automatically updated.

### Fifth Embodiment

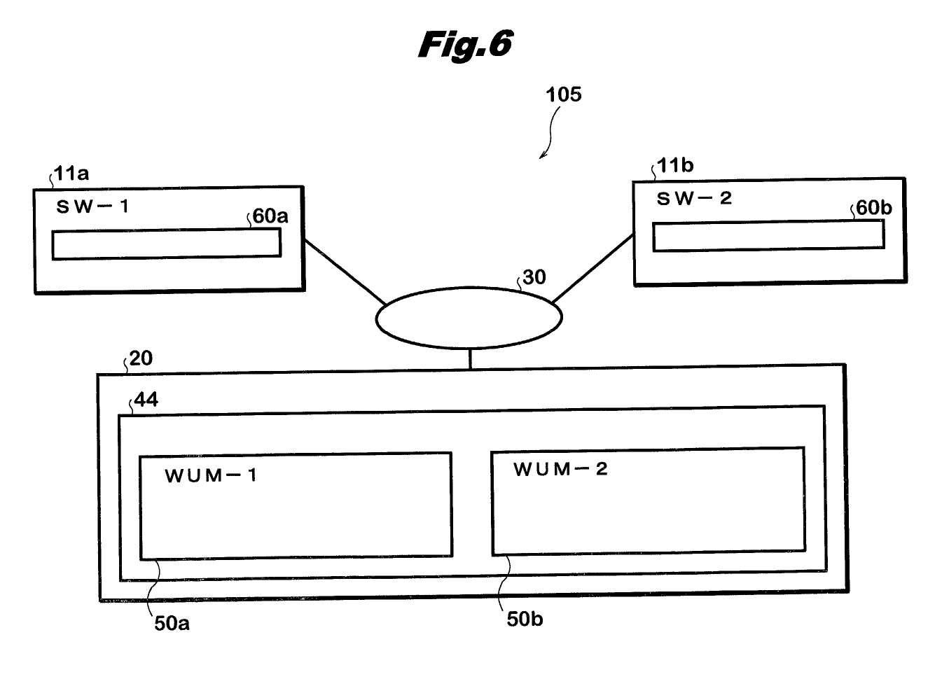

In an electronic settlement system 105 of the fifth embodiment, as shown in FIG. 6, each of server wallets itself has a brand information. The electronic settlement system 105 includes a first server wallet (SW-1) 11a and a second server wallet (SW-2) 11b are connected through the Internet 30 to a user personal computer 20. The first server wallet 11a holds the brand information about the first server wallet (SW-1 brand information) 60a and the second server wallet 11b holds the brand information about the second server wallet (SW-2 brand information) 60b. Contents of the brand information 60a and 60b are the same as those in the case of the third and fourth embodiments. The user PC 20 is provided with a selector 44, a first wallet connecting module (VVUM-1) 50a and a second wallet connecting module (WUM-2) 50b. Configurations of the first wallet connecting module 50a and second wallet connecting module 50b are the same as those in the first to third embodiments.

The selector 44, when receiving the start message from the POS (not shown), accesses to each of the server wallet 11a and the server wallet 11b through the Internet 30 and makes a reference to the brand information 60a and 60b held respectively by the first server wallet 11a and the second server wallet 11b. Then, the selector 44 performs selection of the wallet connecting module corresponding to a brand designated by the start message.

In the electronic settlement system 105 of the fifth embodiment, procedures for the SET-based settlement are taken in accordance with the following steps. In the procedures described below, as in the case of the fourth embodiment, the brand A is used as one of examples of settlement institutions designated by the visual online shop.

(1) When procedures for the settlement for shopping are started, the start message is sent from the POS to the user PC 20.

(2) When the user PC 20 receives the start message, the selector 44 accesses to the first server wallet 11a and the second server wallet 11b through the Internet and makes a reference to the brand information 60a and 60b held respectively by the first server wallet 11a and the second server wallet 11b. This causes the selector 44 to recognize that a server wallet to be used for the settlement using the brand A designated in the message is the first server wallet 11a and selects the first wallet connecting module 50a operated to correspond to the server wallet 11a as the wallet connecting module to be used for settlement.

(3) The selector 44 transfers the start message to the selected first wallet connecting module 50a.

(4) The first wallet connecting module 50a, in accordance with the start message, takes procedures for the SET-based settlement in cooperation with the first server wallet 11a. Moreover, if the brand B, instead of the brand A, is designated by the start message, procedures for the SET-based settlement are taken by the second wallet connecting module 50b and the second server wallet 11b in the same manner as are taken when the brand A is designated.

As described above, in the electronic settlement system 105 of the fifth embodiment, the user's terminal 20 is provided with a plurality of the wallet connecting modules corresponding to a plurality of the server wallets and each of the server wallets holds its own brand information. When the user PC 20 receives the start message for the settlement, the selector 44 makes a reference to each brand information and transfers the message to the wallet connecting module corresponding to the server wallet holding the brand information designated by the start message.

Thus, according to the electronic settlement system 105 of the fifth embodiment, the user can control from the single user terminal so as to use two or more different server wallets selectively and properly. Moreover, the wallet connecting module for the settlement is automatically selected by the selector, thus preventing the user from erroneously selecting the server wallet having any one of the brands other than designated by the visual online shop. Furthermore, in the electronic settlement system 105, since each of the server wallets holds its own brand information, it is not necessary for the user to perform such management for obtaining update information, thus allowing the user to utilize the SET-based settlement easily and conveniently.

### Six Embodiment

In the electronic settlement system of the six embodiment, a single wallet connecting module performs a function of selectively connecting to a specified server wallet out of a plurality of the server wallets that can be used by the user.

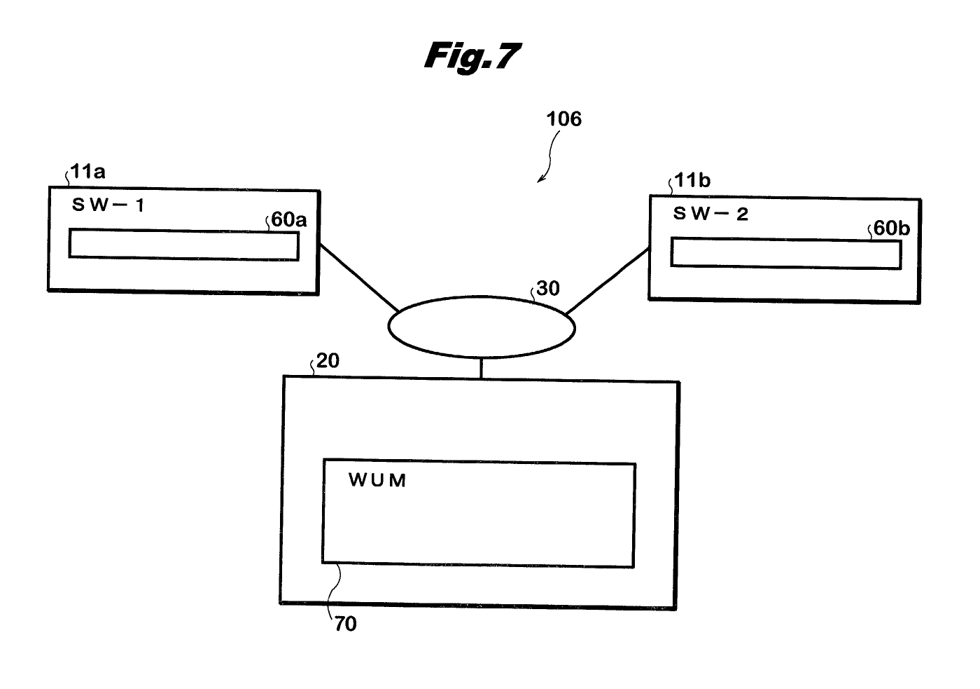

As shown in FIG. 7, in the electronic settlement system 106 of the sixth embodiment, a first server wallet (SW-1) 11a and a second server wallet (SW-2) 11b are connected to a user's personal computer (a user PC) 20 through the Internet 30, as in the case of the fifth embodiment. As in the case of the fifth embodiment, the first server wallet 11a holds brand information 60 and the second server wallet 11b holds brand information 60b. The user PC 20 is provided with a wallet connecting module (WUM) 70. The wallet connecting module 70, when receiving the start message for settlement from the POS (not shown), accesses to each of the first and second server wallets 11a and 11b through the Internet 30. The wallet connecting module 70 makes a reference to each of the brand information 60a and 60b held respectively by the first server wallet 11a and the second server wallet 11b and performs, based on a result of the reference, processing of either of the first server wallet and the second server wallet which corresponds to a brand designated by the start message.

In order for the single wallet connecting module 70 to access selectively to a plurality of the server wallets, for example, a communicating address for each of the server wallets 11a and 11b which is the server wallet that can be used by the user may be given to the wallet connecting module 70. This allows the user to selectively access to the server wallet that can be used by the user, through the user PC 20 and the wallet connecting module 70.

In the electronic settlement system 106 of the sixth embodiment, procedures for the SET-based settlement are taken in accordance with the following steps. In the procedures described below, as in the case of the fifth embodiment, the brand A is used as one of examples of settlement institutions designated by the visual online shop.

(1) When procedures for the settlement for shopping are started, the start message is sent from the POS to the user PC 20.

(2) When the user PC 20 receives the start message, the wallet connecting module 70 accesses to the first server wallet 11a and the second server wallet 11b through the Internet 30 and makes a reference to the brand information 60a and 60b held respectively by the first and second server wallets 11a and 11b. This causes the wallet connecting module 70 to recognize that a server wallet to be used for the settlement using the brand A designated in the message is the first server wallet 11a

(3) The wallet connecting module 70 takes predetermined procedures for the SET-based settlement, based on the above recognition, in accordance with the start message and in cooperation with the first server wallet 11a.

As described above, in the electronic settlement system 106 of the sixth embodiment, the user PC 20 is provided with the single wallet connecting module 70 that can be connected to a plurality of server wallets. At a time of the settlement, the wallet connecting module 70, in order to retrieve the server wallet corresponding to the brand designated by the start message, accesses to each of the server wallets 11a and 11b through the Internet 30. This causes the retrieved server wallet and user PC 20 to be connected to each other and predetermined procedures for the SET-based settlement to be taken.

Thus, according to the electronic settlement system 106 of the six embodiment, without providing the user PC with a plurality of the wallet connecting modules, by being provided with the single wallet connecting module, the user can use two or more different server wallets selectively and properly. Therefore, when the user makes setting for utilization of a plurality of the server wallets, downloading of a single wallet connecting module is all that is needed, thus allowing the user to utilize the SET-based settlement easily and conveniently.

### Seventh Embodiment

The electronic settlement system of a seventh embodiment includes a slave server wallet serving as the server wallet corresponding to settlement institutions and with a master server wallet serving as a proxy server of the salve server wallet. The master server wallet holds brand information about the slave server wallet.

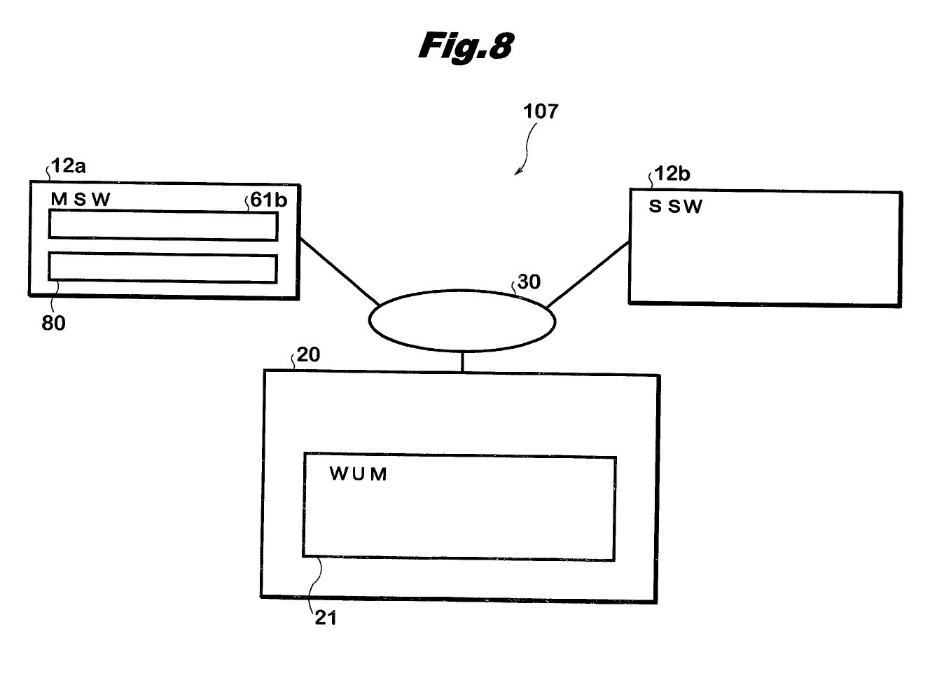

In the electronic settlement system 107, as shown in FIG. 8, the master server wallet (MSW) 12a and the slave server wallet (SSW) 12b are connected to a user personal computer (a user PC) 20 through the Internet 30. The master server wallet 12a holds brand information 61b and is provided with visual wallet connecting module (Visual WUM) 80. The brand information 61b is information showing by which settlement institution the slave server wallet 12b can be used for settlement and whose user's certificate is held by the slave server wallet 12b. The visual wallet connecting module 80 serves as a auxiliary module adapted to implement a function of transferring, in cooperation with the wallet connecting module 21, the start message indicating a request by the user PC 20 to the slave server wallet 12b from the user PC 20 through the master server wallet 12a. At a time of the settlement by the user, by a reference to the brand information 61b made by the master server wallet 12a, the user PC 20 is automatically connected to the slave server wallet 12b through the visual wallet connecting module 80 included in the master server wallet 12a.

In the embodiment, the slave server wallet 12b serves as a server wallet corresponding to the brand B. The slave server wallet 12b holds the user's certificate to be used for the settlement using the brand B. The personal computer 20 is provided with the wallet connecting module (WUM) 21. As the wallet connecting module 21, the same wallet connecting module as has been conventionally used can be employed. Therefore, as the user personal computer 20, the conventional computer can be used. In the electronic settlement system 107 of the seventh embodiment, procedures for the SET-based settlement are taken in accordance with the following steps. In the procedures described below, the brand B is used as one of examples of settlement institutions designated by the visual online shop.

(1) When procedures for the settlement for shopping are started, the start message is sent from the POS to the user PC 20.

(2) When the user PC 20 receives the start message, the wallet connecting module 21 included in the user PC 20 is started.

(3) The wallet connecting module 21 transfers the start message to the master server wallet 12a.

(4) The master server wallet 12a, when recognizing that it does not hold the user's certificate corresponding to the brand B designated by the start message, makes a reference to the brand information 61b and comes to know that the user can use the slave server wallet 12b for the settlement by using the brand B.

(5) The master server wallet 12a transfers the received start message to the visual wallet connecting module 80 in order to send the start message to the slave server wallet 12b. This causes the master server wallet 12a to operate as the visual slave server wallet 12b for the wallet connecting module 21 of the user PC 20 and the visual wallet connecting module 80 to operate as the visual wallet connecting module 21 for the slave server wallet 12b.

(6) The slave server wallet 12b, when receiving the start message through the master server wallet 12a from the user PC 20, takes procedures for the SET-based settlement in accordance with the start message. The master server wallet 12a serves as the proxy server of the slave server wallet 12b to implement an intermediate function of connecting the wallet connecting module 21 to the slave server wallet 12b.

In the electronic settlement system 107 of the seventh embodiment, as the slave server wallet, the single slave server wallet 12b is provided, however, a plurality of the server wallets may be connected through the Internet 30. In this case, two or more pieces of the brand information corresponding to a plurality of the slave server wallets are incorporated collectively into the brand information 61b.

As described above, the electronic settlement system 107 is provided with the master server wallet 12a which serves as the proxy server of the slave server wallet 12b. At a time of the settlement, processing of the settlement is performed between the wallet connecting module 21 and the slave server wallet 12b through the master server wallet 12a.

Thus, according to the electronic settlement system 107 of the seventh embodiment, without providing the user PC with a plurality of the wallet connecting modules and by having the single wallet connecting module, the user can control from the single user terminal so as to use two or more different server wallets selectively and properly.

### Eighth Embodiment

In the electronic settlement system of an eighth embodiment, as in the case of the seventh embodiment, a master server wallet and a slave server wallet. The slave server wallet of the eighth embodiment holds only a certificate which is issued for each brand of each of the server wallets and is given to each user and transfers the certificate required for settlement to the master server wallet. This certificate is used to certify that a user holding this certificate issued by a settlement institution can make the SET-based settlement of accounts at the settlement institution and predetermined procedures for the settlement is taken by using this certificate. In the eighth embodiment, the certificate of the user who is going to settle accounts is transferred from the slave server wallet to the master server wallet and then the master server wallet takes the procedures for the settlement using the certificate.

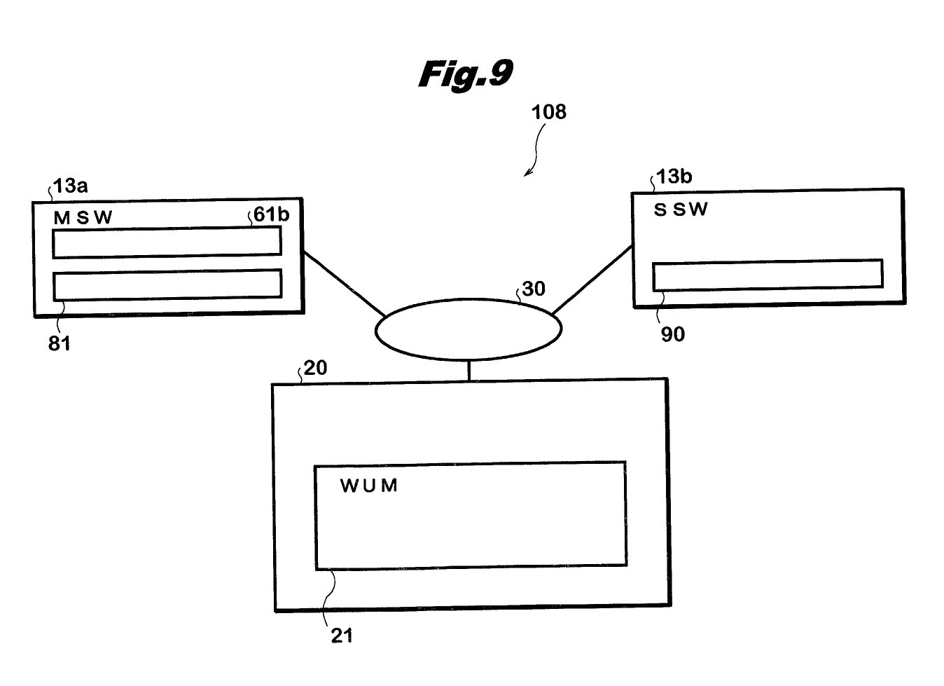

The electronic settlement system 108 of the eighth embodiment, as shown in FIG. 9, is provided with the master server wallet (MSW) 13a and the slave server wallet (SSW) 13b are connected to a user personal computer (user PC) 20 through the Internet 30. The master server wallet 13a has brand information 61b and a certificate acquiring module 81. The brand information 61b, as in the case of the seventh embodiment, is information indicating that the slave server wallet 13b has a user certificate (i.e., settlement institution certificate) of specified brands. In the embodiment, the specified brand is a brand B and the slave server wallet 13b holds a certificate 90 which is a certificate of the brand B that can be used by the user operating the user PC 20.

As described above, the slave server wallet 13b holds the user certificate of the brand B. The certificate acquiring module 81 of the master server wallet 13a performs a function of acquiring each of the certificates of each user from the slave server wallet 13b. The master server wallet 13a, when recognizing, by a start message from the user PC 20, that the master server wallet 13a cannot takes procedures for settlement for itself, that is, that the master server wallet 13a does not hold the certificate 90 required for procedures for the settlement, makes a reference to the brand information 61b. The master server wallet 13a, when coming to know, by the brand information 61b, that the slave server wallet 13b has the certificate 90, acquires the certificate 90 from the slave server wallet 13b through the certificate acquiring module 81. Thus, the master server wallet 13a performs the SETbased settlement in cooperation with the wallet connecting module 21. Configurations of the user PC 20 are the same as those in the seventh embodiment.

In the electronic settlement system 108 of the eighth embodiment, procedures for the SET-based settlement are taken in accordance with the following steps. In the procedures described below, the brand B is used as one of examples of settlement institutions designated by the visual online shop.

(1) When procedures for the settlement for shopping are started, the start message is sent from the POS to the user PC 20.

(2) When the user PC 20 receives the start message, the wallet connecting module 21 included in the user PC 20 is started.

(3) The wallet connecting module 21 transfers the start message to the master server wallet 13a.

(4) The master server wallet 13a, when coming to know that it does not have the user certificate 90 of the brand B designated by the start message, makes a reference to the brand information 61b and, as a result, it comes to know that the slave server wallet 13b holds the certificate 90.

(5) The master server wallet 13a starts the certificate acquiring module 81 and obtains the certificate 90 from the slave server wallet 13b through the certificate acquiring module 81.

(6) The master server wallet 13a, using the certificate 90 of the brand B obtained from the slave server wallet 13b and in accordance with the start message, takes predetermined procedures for the SET-based settlement.

As described above, in the electronic settlement system 108, the slave server wallet 13b holds a certificate of its brand for each of users and, when procedures for the SET-based settlement are taken, the master server wallet 13a obtains the user's certificate 90 required for the settlement procedures from the slave server wallet 13b. Settlement processing is performed by cooperation of the master server wallet 13a and the wallet connecting module 21 accordingly.

Thus, according to the electronic settlement system 108 of the eighth embodiment, without providing the user PC with a plurality of the wallet connecting modules and by having the single wallet connecting module, the user can control from the single user terminal so as to use two or more different server wallets selectively and properly. Moreover, as described above, if only the slave server wallet holds the certificate of its brand for each of the users, wallet functions for the settlement processing are not required. Therefore, the management of wallet functions on the master server wallet is all that is needed. That is, since the slave server wallet does not perform predetermined settlement processing, high performance of the user computer is not required. Furthermore, in the electronic settlement system 108 of the eighth embodiment, as in the case of the seventh embodiment, the single slave server wallet is provided, however, a plurality of the salve server wallets may be installed. In this case, two or more pieces of the brand information corresponding to a plurality of the slave server wallets may be incorporated collectively into the brand information.

### Ninth Embodiment

An electronic settlement system of a ninth embodiment, as in the case of the electronic settlement system of the eighth embodiment, is provided with a master server wallet and a slave server wallet. The master server wallet of the ninth embodiment holds information about the slave server wallet (namely slave server wallet information).

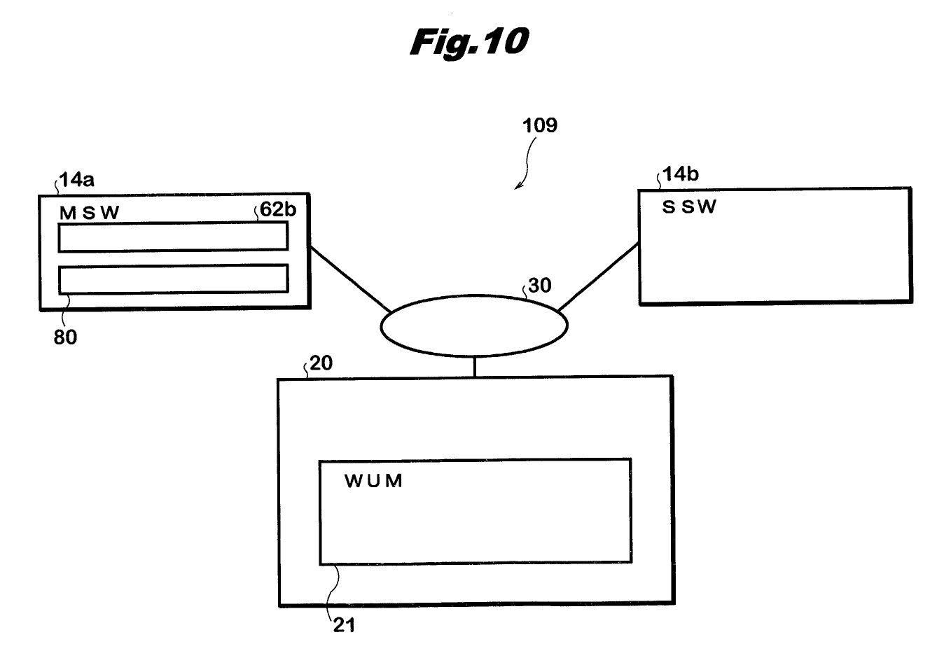

In the electronic settlement system 109 of the ninth embodiment, as shown in FIG. 10, the master server wallet (MSW) 14a and a slave server wallet (SSW) 14b are connected to a user personal computer (user PC) 20 through the Internet 30. The master server wallet 14a has slave server wallet information (SSW information) 62b and is provided with a visual wallet connecting module (visual WUM) 80. The slave server wallet information 62b, in the embodiment, is information indicating that the slave server wallet 4b exists as a server wallet used to take procedures for the SET-based settlement in the electronic settlement system 109. The visual wallet connecting module 80, as in the case of the seventh embodiment, acts as a auxiliary module for the wallet connecting module 21 used to transfer a request from a user personal computer 20. The master server wallet 14a, when receiving, from a terminal of the user, a start message including information that a user is going to use a specified brand for settlement and if the master server wallet 14a itself does not hold a certificate of the user required to settle using the designated brand, acts to have the user designate any one of the slayer wallets that the user wants to use out of the slave servers based on the slave server information 62b. The master server wallet 14a acts to cause the user PC 20 to be connected to a slave server wallet designated by the user, thereby serving as a proxy server of the slave server wallet.

Configurations of the user personal computer 20 are the same as in the case of the eighth embodiment. Also, configurations of the slave server wallet 14b are the same as in the case of the seventh embodiment.

In the electronic settlement system 109 of the ninth embodiment, procedures for the SET-based settlement are taken in accordance with the following steps. In the procedures described below, the brand B is used as one of examples of settlement institutions designated by the visual online shop.

(1) When procedures for the settlement for shopping are started, the start message is sent from the POS to the user PC 20.

(2) When the user personal computer 20 receives the start message, the wallet connecting module 21 of the PC 20 is started.

(3) The wallet connecting module 21 transfers the start message including the information that the brand designated by the visual online shop for the settlement is the B brand, to the master server wallet 14a.

(4) The master server wallet 14a, when coming to know that the master server wallet 14a does not hold the user's certificate of the brand B designated by the start message, instructs the user to select a slave server wallet used to take procedures for the settlement. In the embodiment, since the slave server wallet 14b is provided as a slave server wallet for the electronic settlement system 109, the user selects the slave server wallet 14b. If a plurality of slave server wallets is provided, the user is allowed to select any one of the slayer server wallets that the user wants to use for the settlement.

(5) As described above, when the user selects the slave server wallet 14b, a result of the selection is sent to the master server wallet 14a.

(6) The master server wallet 14a transfers the start message to the visual wallet connecting module 80. The master server wallet 14a acts as the visual slave server wallet 14b for the wallet connecting module 21 of the user PC 20 and the visual wallet connecting module 80 acts as the visual wallet connecting module 21 for the slave server wallet 14b. This causes the master server wallet 14a to function as a proxy server of the slave server 14b.

(7) The slave server wallet 14b takes procedures for the SET-based settlement in accordance with the start message that the slave server wallet 14b has received from the master server wallet 14a through the visual wallet connecting module 80. That is, the master server wallet 14a, as in the case of the seventh embodiment, serves as the proxy server of the slave server wallet 14b to implement an intermediate function of connecting the user PC 20 to the slave server wallet 14b.

As described above, in the electronic settlement system 109, the master server wallet 14a has information that the slave server wallet 14b is provided as the slave server wallet of the electronic settlement system. If the master server wallet 14a does not have the certificate of the user when receiving the start message from the user PC 20, the master server wallet 14a prompts the user to designate the slave server wallet holding the certificate.

The master server wallet 14a, based on the designation by the user, acts as the proxy server of the slave server wallet 14b.

Thus, according to the electronic settlement system 109 of the ninth embodiment, without providing the user PC with a plurality of the wallet connecting modules and by having only the single wallet connecting module, the user can control from the single user terminal so as to use two or more different server wallets selectively and properly. Since information about the certificate as described above is not included in the slave server wallet information, even if the certificate held by the slave server wallet is changed, the slave server wallet information is not affected by the change. Therefore, even if the certificate held by the slave server wallet is added, changes of the slave server information by the master server wallet are not required.

### Tenth Embodiment

An electronic settlement system of a tenth embodiment is provided with a master server wallet and a slave server wallet. The master server wallet, if a certificate not held by the master server wallet at a time of taking procedures for settlement is required, acts to have a user notify the master server wallet of an address for communication of a slave server wallet corresponding to a brand desired by the user.

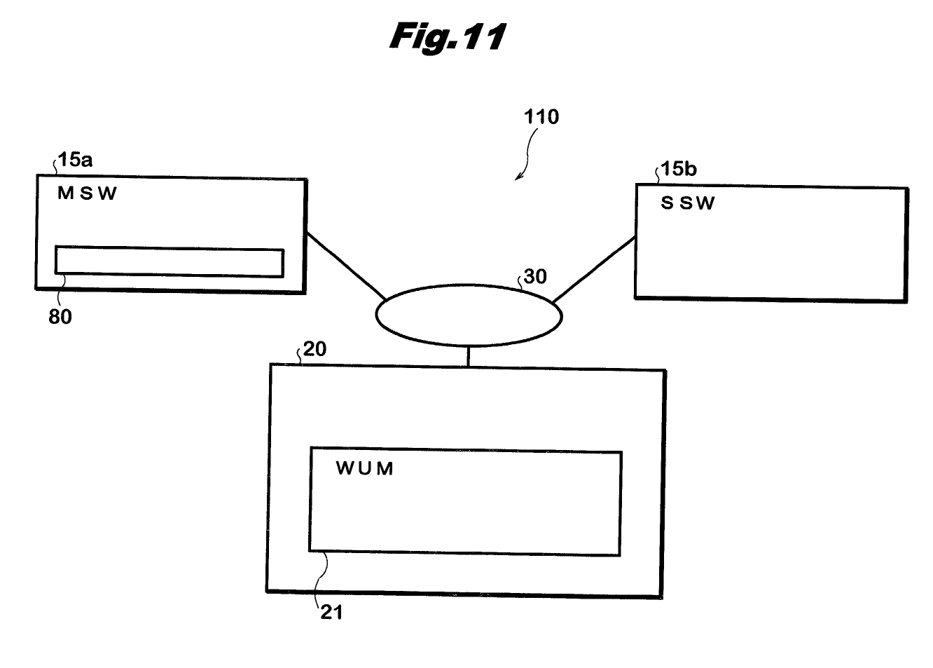

In the electronic settlement system 110 of the tenth embodiment, as shown in FIG. 11, the master server wallet (MSW) 15a and the slave server wallet (SSW) 15b are connected to a user personal computer (user PC) 20 through the Internet 30, as in the case of the electronic settlement system 109 of the ninth embodiment. The master server wallet 15a has a visual wallet connecting module 80, as in the case of the ninth embodiment. Configurations of the slave server wallet 15b are the same as those in the case of the seventh and ninth embodiments. The user personal computer 20 is provided with a wallet connecting module 21. As this wallet connecting module 21, the conventional wallet connecting module may be used. Configurations of the user personal computer 20 are the same as those in the case of the ninth embodiment.

In the electronic settlement system 110 of the tenth embodiment, procedures for the SET-based settlement are taken in accordance with the following steps. In the procedures described below, the brand B is used as one of examples of settlement institutions designated by the visual online shop.

(1) When procedures for the settlement for shopping are started, the start message is sent from the POS to the user PC 20.

(2) When the user personal computer 20 receives the start message, the wallet connecting module 21 of the PC 20 is started.

(3) The wallet connecting module 21 transfers the start message including the information that the brand designated by the visual online shop for the settlement is the B brand, to the master server wallet 16a.

(4) The master server wallet 15a, when coming to know that the master server wallet 15a does not hold the user's certificate of the brand B designated by the start message, sends out a message prompting the user personal computer 20 to input a communication address of a slave server wallet corresponding to the brand B.

(5) The user, in accordance with the message from the master server wallet 15a, inputs the communication address of the slave server wallet 1b being a slave server wallet corresponding to the brand B to the user PC 20.

(6) The master server wallet 16a, using the communication address of the slave server wallet 15b given by the user, accesses to the slave server wallet 15b for the wallet connecting module 80. This causes the master server wallet 15a to act as the visual slave server wallet 15b for the wallet connecting module 21 of the user personal computer 20 and causes the visual wallet connecting module 80 to act as the visual wallet connecting module 21 for the slave server wallet 15b.

(7) The slave server wallet 15b receives the start message from the user PC 20 through the master server wallet 16a and takes procedures for the SET-based settlement in cooperation with the wallet connecting module 21 of the user PC 20.

As described above, the electronic settlement system 110 is provided with the master server wallet 15a as a proxy server of the slave server wallet 15b and the slave server wallet 15b obtains the communication address of the slave server wallet 15b from the user. This causes the master server wallet 15a to connect the user PC 20 to the slave server wallet 15b.

Thus, according to the electronic settlement system 110 of the tenth embodiment, without providing the user PC with a plurality of the wallet connecting modules and by having only the single wallet connecting module, the user can control so as to use two or more different server wallets selectively and properly. This allows the user to access selectively to a plurality of server wallets using only the single terminal to take procedures for the settlement. Moreover, since the master server wallet holds no real-time information about the slave server wallet, even when the slave server wallet that can be used by the user is change, notification of the change to the master server wallet is not required. That is, even if the brand of the slave server wallet is changed or even if the number of the slave server wallets is increased or decreased, it is not necessary to change the data on the master server wallet side.

### Eleventh Embodiment

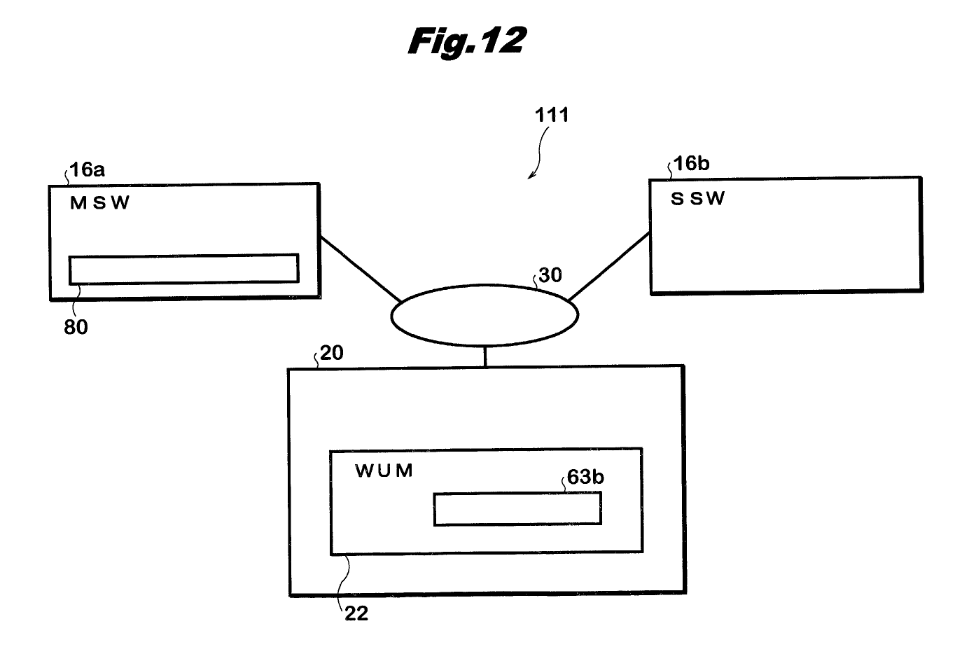

In the electronic settlement system of an eleventh embodiment of the present invention, the same brand information 61b as that in the seventh and eighth embodiment is provided. In the electronic settlement system 111 of the eleventh embodiment, as shown in FIG. 12, a master server wallet (MSW) 16a and a slave server wallet (SSW) 16b are connected to a user personal computer (user PC) 20 through the Internet 30. Configurations of the slave server wallet 16b are the same as those of the slave server wallet in the seventh, ninth and tenth embodiments. The master server wallet 16a has the same visual wallet connecting module (visual WUM) 80 as in the case of the seventh, ninth and tenth embodiments. The master server wallet 16a receives a start message including information about the brand designated by the visual online shop and the same brand information 63b as in the seventh and eighth embodiments, from the user personal computer 20. The master server wallet 16b, when recognizing, by the start message, that the master server wallet 16b cannot take procedures for settlement using the brand, makes a reference to the brand information 63b from the user PC 20. The master server wallet 16b, when coming to know, by the brand information 63b, that the master server wallet 16b can take procedures for settlement by using the designated brand, acts as a proxy server of the slave server wallet 16b to implement an intermediate function of connecting the user personal computer 20 to the slave server wallet 16b. The user personal computer 20 is provided with a wallet connecting module (WUM) 22 which holds the brand information 63b.

In the electronic settlement system 111 of the eleventh embodiment, procedures for the SET-based settlement are taken in accordance with the following steps. In the procedures described below, the brand B is used as one of examples of settlement institutions designated by the visual online shop.

(1) When procedures for the settlement for shopping are started, the start message is sent from the POS to the user PC 20.

(2) When the user personal computer 20 receives the start message, the wallet connecting module 22 of the PC 20 is started.

(3) The wallet connecting module 22 sends the start message containing the information that the brand designated by the visual online shop for the settlement is the B brand, together with the brand information 63b, to the master server wallet 16a.

(4) The master server wallet 16a, when coming to know, after having received the start message and brand information 63b, that the master server wallet 16a does not hold the user's certificate of the brand B, makes a reference to the brand information 63b and comes to know that procedures for settlement using the brand B can be taken by the slave server wallet 16b.

(5) The master server wallet 16a transfers the start message from the user PC 20 to the visual wallet connecting module 80. This causes the master server wallet 16a to act a visual slave server wallet 16b for the wallet connecting module 22 of the user PC 20 and the visual wallet connecting module 80 to act as the visual wallet connecting module 22 for the slave server wallet 16b.

(6) The slave server wallet 16b, in accordance with the start message received from the user PC 20 through the master server wallet 16a, takes procedures for the SET-settlement, in cooperation with the user PC 20.

As described above, the electronic settlement system 111 is provided with the master server wallet 16a as the proxy server of the slave server wallet 16b. In order to perform the settlement between the user PC 20 and the slave server wallet 16b through the master server wallet 16a, the brand information 63b is given from the user PC 20 to the master server wallet 16b.

Thus, according to the electronic settlement system 111 of the eleventh embodiment, without providing the user PC with a plurality of the wallet connecting modules and by having only the single wallet connecting module, the user can control so as to use two or more different server wallets selectively and properly. This allows the user to access selectively to a plurality of server wallets using only the single terminal to take procedures for the settlement. Moreover, since the user holds the brand information, it is not necessary for the master server wallet to manage information about the slave server wallet.

### Twelfth Embodiment

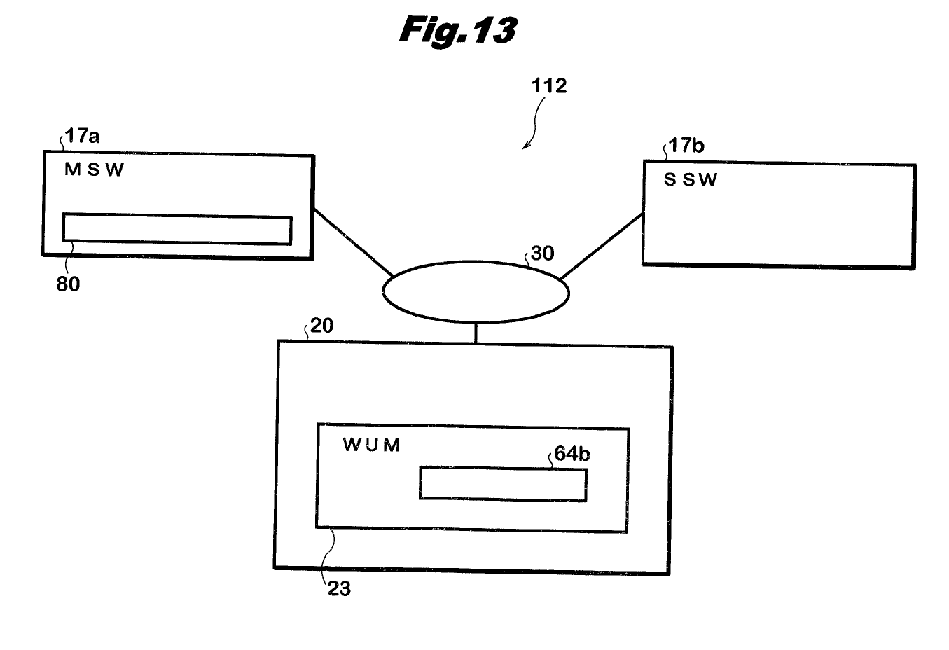

In the electronic settlement system of an eleventh embodiment of the present invention, the same brand information 61b as that in the ninth embodiment is provided to the wallet connecting module of the PC 20. In the electronic settlement system 112 of the twelfth embodiment, as shown in FIG. 13, a master server wallet (MSW) 17a and a slave server wallet (SSW) 17b are connected to a personal computer (a user PC) 20 through the Internet 30. Configurations of the slave server wallet 17b are the same as those in the case of the seventh and ninth embodiments and the eleventh embodiment. The master server wallet 17a is provided with the same visual wallet connecting module (visual WUM) 80 as in the case of the seventh and ninth embodiment to the eleventh embodiment. The master server wallet 17a receives the start message for the electronic settlement including information about the brand designated by the visual online shop and the slave server wallet information 64 being the same as that of the slave server information 62b in the ninth embodiment, from the user personal computer 20. The master server wallet 17a, when recognizing, by the start message, that the master server wallet 17a cannot take procedures for settlement using the brand, makes a reference to the brand information 64b from the user PC 20. The master server wallet 17a, when coming to know, by the slave server wallet information 64b, that the slave server wallet 17b exists as the slave server wallet of the electronic settlement system 112, notifies the user of the no-existence of the slave server wallet 17b to receive the designation of the slave server wallet 17b from the user. The master server wallet 17a acts as a proxy server of the slave server wallet 17b to implement an intermediate function of connecting the user personal computer 20 to the slave server wallet 17b. The user PC 20 is provided with a wallet connecting module (WUM) 23, which holds the slave server wallet information (SSW) 64b. The slave server wallet 64b is information showing which slave server wallet exists in the electronic settlement system 112, as in the case of the slave server wallet 62b of the ninth embodiment.

In the electronic settlement system 112 of the twelfth embodiment, procedures for the SET-based settlement are taken in accordance with the following steps. In the procedures described below, the brand B is used as one of examples of settlement institutions designated by the visual online shop.

(1) When procedures for the settlement for shopping are started, the start message is sent from the POS to the user PC 20.

(2) When the user personal computer 20 receives the start message, the wallet connecting module 23 of the user PC 20 is started.

(3) The wallet connecting module 23 sends the start message containing the information that the brand designated by the visual online shop for the settlement is the B brand and the slave server information 64b, to the master server wallet 17a.

(4) The master server wallet 17a, when coming to know, after having received the start message and the slave server wallet information 64b, that the master server wallet 17a does not hold the user's certificate of the brand B, makes a reference to the slave server wallet information 64b and comes to know that the slave server wallet 17b is available as the slave server wallet of the electronic settlement system 112. The master server wallet 17a acts to have the user select a server wallet to be used instead of the master server wallet 17a out of the server wallets contained in the slave server wallet information 64b. In the embodiment, since the single slave server wallet 17b only is available as the usable slave server wallet, the user selects the slave server wallet 17a. Moreover, if there are two or more slave server wallets, the user selects one out of the two or more slave server wallets.

(5) As described above, when the user selects the slave server wallet 17b, the result of selection is notified to the master server wallet 17a.

(6) The master server wallet 17a, in response to the notification from the user PC 20, transfers the start message to the visual wallet connecting module 80 to send it to the slave server wallet 17b. This causes the master server wallet 17a to act as the visual slave server wallet 17b for the wallet connecting module 23 of the user PC 20 and the visual wallet connecting module 80 to act as the visual wallet connecting module 23 for the slave server wallet 17b.

(7) The slave server wallet 17b takes procedures for the SET-settlement in accordance with the start message fed through the master server wallet 17a from the user PC 20, in cooperation with the user PC 20.

As described above, in the electronic settlement system 112, the wallet connecting module 23 of the user PC is fed with the slave server information 64b about which slave server wallet exists as the slave server wallet of the electronic settlement system. The master server wallet 17a acts to have the user to designate the slave server wallet having the user's certificate required for the settlement and the master server wallet 17a, in accordance with the designation, serves as a proxy server between the user PC 20 and the slave server wallet 17b.

Thus, according to the electronic settlement system 112 of the twelfth embodiment, without providing the user PC with a plurality of the wallet connecting modules and by having only the single wallet connecting module, the user can control so as to use two or more different server wallets selectively and properly. This allows the user to access selectively to a plurality of server wallets using only the single terminal to take procedures for the settlement. Moreover, since the user does not hold the slave server wallet information, it is not necessary for the master server wallet to manage the information about the slave server wallet. Even if the certificate held by the slave server wallet is changed, the slave server wallet information held by the wallet connecting module of the user terminal is not affected by the change. Therefore, even if the slave server wallet is added, no change to be made on the user PC is required.

It is apparent that the present invention is not limited to the above embodiments but may be changed and modified without departing from the scope and spirit of the invention. For example, in the above embodiments, the server wallets employed in the present electronic settlement system are used for the SET-based settlement, however, the electronic settlement system of the present invention can be applied not only to the SET-based settlement but also a variety of settlement protocols.

What is claimed is:

1. An electronic settlement system comprising:
a shop connected to a communication network;
a plurality of terminals connectable to said network;
a plurality of settlement institutions connected to said network;
servers connected to said network and provided so as to correspond to each of said settlement institutions, which are operated to manage two or more pieces of software installed for each customer in order to take procedures for settlement of electronic commerce for a plurality of customers using said shop on said communication network by operating each of said terminals; and
wherein each of said terminals is provided with a plurality of connecting modules installed so as to correspond to each of said servers and operated to connect each of said terminals to each of said servers through said communication network so that said customer is able to take procedures for settlement and with a selecting module used to select said connecting module corresponding to said server from said two or more connecting modules provided to each of said terminals to use said server corresponding to said settlement institution.

2. The electronic settlement system according to claim 1, wherein each of said terminals is operated to receive a message showing a request for said procedures for settlement from said shop and, after having received said message, in order to start said procedures for settlement, transfers said message from said selecting module through a desired connecting module selected out of said connecting modules to said server corresponding to said desired connecting module.

3. The electronic settlement system according to claim 2, wherein said selecting module, before each of said terminals receives said message, is operated to prompt said customer to select said connecting module using a screen display which is provided to facilitate selection of said connecting module corresponding to said settlement institution that each of said customers is able to use for settlement and wherein said desired connecting module is the one selected by each of said customers using said screen display.

4. The electronic settlement system according to claim 2, wherein said selecting module, when each of said terminals has received said message, is operated to prompt said customer to select said connecting module using a screen display which is provided to facilitate selection of said connecting module corresponding to said settlement institution that each of said customers is able to use for settlement and wherein said desired connecting module is the one selected by each of said customers using said screen display.

5. The electronic settlement system according to claim 2, wherein said selecting module, when each of said terminals has received said message, is operated to select said connecting module used to connect each of said terminals to said server corresponding to said settlement institution designated by said message, based on information indicating which settlement institution allows each of said servers corresponding to each of said two or more connecting modules installed on each of said terminals to be used for electronic settlement.

6. The electronic settlement system according to claim 5, wherein each piece of said information is given to said selecting module which then transfers said message to said connecting module selected based on each piece of said information.

7. The electronic settlement system according to claim 5, wherein each piece of said information is given to each of said connecting modules and said selecting module then transfers said message to said connecting module selected based on each piece of said information held by each of said connecting modules.

8. The electronic settlement system according to claim 5, wherein each piece of said information is given to each of servers and said selecting module then transfers said message to said connecting module based on each piece of said information held by each of said servers.

9. An electronic settlement system comprising:
a shop connected to a communication network;
a plurality of terminals connectable to said network;
a plurality of settlement institutions connected to said network;
servers connected to said network and provided so as to correspond to each of said settlement institutions, which are operated to manage two or more pieces of software installed for each customer in order to take procedures for settlement of electronic commerce for a plurality of customers using said shop on said communication network by operating each of said terminals; and
wherein each of said terminals is provided with a single connecting module used to connect each of said terminals to a desired server selected out of said two or more servers through said communication network so that said customer is able to take said procedures for settlement.

10. The electronic settlement system according to claim 9, wherein said connecting module is used to automatically connect each of said terminals to said server based on information indicating which settlement institution allows each of said servers to be used for electronic settlement.

11. The electronic settlement system according to claim 10, wherein each of said servers holds each piece of said information and each of terminals obtains each piece of said information from each of servers through said connecting modules.

12. The electronic settlement system according to claim 11, wherein each of said terminals receives a message showing a request for said procedures for settlement from said shop and, after having received said message, in order to start said procedures for settlement, transfers said message through said connecting module to said server corresponding to said settlement institution designated by said message being said server selected based on each piece of said information.

13. The electronic settlement system according to claim 10, wherein a proxy server enabling selective connection between each of said terminals and each of said servers is connected as a master server to said communication network and each of said terminals is able to be connected through said master server to each of said servers as each of slave servers being provided so as to correspond to each of said settlement institutions.

14. The electronic settlement system according to claim 13, wherein each of said terminals receives said message showing said request for said procedures for settlement from said shop and, after having received said message, in order to start said procedures for settlement, transfers said message through said connecting modules to said master servers.

15. The electronic settlement system according to claim 13, wherein said master server is provided with a auxiliary connecting module used to connect each of said terminals to each of slave servers through said master server in cooperation with said connecting module of each of said terminals.

16. The electronic settlement system according to claim 15, wherein each of said information is stored collectively in said master server and said master server is used to connect each of said terminals through said auxiliary connecting module to said desired slave server based on said collective information.

17. The electronic settlement system according to claim 13, wherein said master server is provided with a certificate acquiring module used to obtain, from each of said slave servers, a certificate to certify that each customer is a duly authorized person for said procedures for settlement, which is given to each of said customers who is allowed to use said settlement institution.

18. The electronic settlement system according to claim 17, wherein each piece of said information is stored collectively in said master server and said master server obtains, based on said collective information, in order to take procedures for settlement instead of each of said slave servers, said certificate through said certificate acquiring module from said desired slave server.

19. The electronic settlement system according to claim 13, wherein said master server holds slave server information about said slave servers connected to said communication network.

20. The electronic settlement system according to claim 9, wherein a proxy server enabling selective connection between each of said terminals and each of said servers is connected as a master server to said communication network and each of said terminals is able to be connected through said master server to each of said servers as each of slave servers being provided so as to correspond to each of said settlement institutions.

21. The electronic settlement system according to claim 20, wherein said master server, in order to connect each of said terminals to said each of slave servers desired by each of said customers, receives a notification about communication addresses of said slave server through said connecting module from said terminal of said customer.

22. The electronic settlement system according to claim 13, wherein each piece of said information is collectively stored in said connecting module of each of said terminals and, each of said terminals, in order to connect each of said terminals to said desired slave server through said master server, sends said collective information from said connecting module to said master server.

23. The electronic settlement system according to claim 13, wherein said connecting module of each of said terminals is fed with said slave server information about said slave servers connected to said communication network and each of said terminals sends said slave server information from said connecting module to said master server to connect each of terminals to said desired slave server through said master server.
